(19) United States
(12) Patent Application Publication
(10) Pub. No.: US 2006/0218251 A1
(43) Pub. Date: Sep. 28, 2006

(54) AV server, AV contents reproducing apparatus, AV contents transmitting method, program and recording medium

(75) Inventor: Takumi Tanabe, Hyogo (JP)

Correspondence Address: RATNERPRESTIA, P O BOX 980, VALLEY FORGE, PA, 19482-0980, US

(73) Assignee: MATSUSHITA ELECTRIC INDUSTRIAL CO., LTD.

(21) Appl. No.: 11/079,029

(22) Filed: Mar. 14, 2005

(51) Int. Cl. G06F 15/177

(52) U.S. Cl. 709/220

(57) ABSTRACT

In reproducing the AV contents, the information concerning the configuration of reproduction block (e.g., GOP) composing the AV contents is needed. In the case of network reproduction, it was requisite that an AV contents reproducing apparatus acquired this information from an AV server. The present invention provides an AV contents reproducing method, an AV server and an AV contents reproducing apparatus in which this information is unnecessary to transmit or receive. The AV contents reproducing apparatus transmits a reproduction start request by specifying the start request position, and the AV server starts to transmit the AV contents from the top position of reproduction block (e.g., GOP) near the start request position.

### BACKGROUND OF THE INVENTION

1. Field of the Invention

The present invention relates to an AV server storing the AV contents such as video, audio or image, an AV contents reproducing apparatus, connected via a network to the AV server, of reproducing the AV contents via the network, an AV contents transmitting method of transmitting the AV contents such as image or voice, a program and a recording medium.

2. Related Art of the Invention

Generally, the AV contents are often compressed by a compression scheme such as MPEG. In this case, the AV contents are divided into reproduction blocks (e.g., GOP in the MPEG) in a predetermined manner, and can be decoded within the reproduction blocks without referring to other portions of the AV contents. It is required to input data into a decoder from the top of reproduction block. Accordingly, when the AV contents are reproduced via the network, it is required to make transmission and reception in a unit of reproduction block.

The conventional AV contents AV server and AV contents reproducing apparatus were described in Japanese Patent Laid-Open No. 2003-46928 (page 1, FIG. 1), for example. In this Japanese Patent Laid-Open No. 2003-46928 (page 1, FIG. 1), the AV server analyzes beforehand the AV contents, and divides the AV contents at predetermined time intervals. At this time, the AV contents are divided in a unit of reproduction block. The correspondence information between each block of the AV contents and its reproduction time information or size is created and held within the AV server.

FIGS. 10(a) and 10(b) show two examples of such correspondence information.

FIG. 10(a) shows the correspondence information between each GOP and the size, when the reproduction block is GOP. That is, in the correspondence information of FIG. 10(a), GOP designates the reproduction block, and the start position (bytes) indicates the top position of each GOP in terms of the number of bytes from the top of the AV contents.

Also, FIG. 10(b) shows the correspondence information between each GOP and the reproduction time information, when the reproduction block is GOP. That is, in the correspondence information of FIG. 10(b), GOP designates the reproduction block, and the start position (milliseconds) indicates the top position of each GOP in terms of the reproduction time from the top of the AV contents.

Before the AV contents are reproduced via the network, the AV server transmits the correspondence information as shown in FIG. 10(a) or 10(b) to the AV contents reproducing apparatus. The AV contents reproducing apparatus requests the AV server to transmit the AV contents in a unit of block, seeing the transmitted correspondence information.

In this way, the AV contents reproducing apparatus is allowed to input each portion of the AV contents from the top of reproduction block into its own decoder.

With the above method, however, a mechanism for interpreting the correspondence information is required on the side of the AV contents reproducing apparatus, increasing the load on the AV contents reproducing apparatus. Since the size of correspondence information increases along with the larger size of AV contents, there is possibility that the memory capacity is insufficient on the side of the AV contents reproducing apparatus. Also, the AV contents reproducing apparatus incapable of interpreting the correspondence information can not make the reproduction via the network. Furthermore, when the substance of the AV contents is changed due to editing operation on the AV server, the correspondence information is not matched with the actual situation of the AV contents, possibly causing an unconformity.

In the light of the above-mentioned problems, it is an object of the present invention to provide an AV server, an AV contents reproducing apparatus, an AV contents transmitting method, a program and a recording medium in which when the AV contents recorded in the AV server are reproduced via the networks the AV contents are reproduced from the top of reproduction block, even if the AV contents reproducing apparatus does not have the correct information concerning the reproduction blocks composing the AV contents, whereby the AV contents reproducing apparatus does not need to inquire the AV server about the information concerning the reproduction block of the AV contents, or interpret such information, reducing the load on the AV contents reproducing apparatus and simplifying the constitution.

### SUMMARY OF THE INVENTION

In order to accomplish the above object, the 1^{st} aspect of the present invention is an AV server comprising:

store means of holding one or more AV contents containing video, image and/or audio and composed of a plurality of reproduction blocks;

reproduction request receiving means of receiving an AV content identifier that is the information for identifying the AV content and a reproduction request having the start request position information that is the information indicating the start request position designating from which position to start the reproduction for the AV content identified by said AV content identifier;

transmit data determining means of determining the top of reproduction block as the transmission start position when said start request position indicated by said start request position information is coincident with the top of reproduction block, and determining the top of reproduction block before or after said start request position indicated by said start request position information as the transmission start position when said start request position indicated by said start request position information is not coincident with the top of reproduction block; and

transmitting means of transmitting the AV content identified by said AV content identifier provided in said reproduction request received by said reproduction request receiving means from said transmission start position.

The 2^{nd} aspect of the present invention is the AV server according to the 1^{st} aspect of the present invention, wherein said transmit data determining means determines the top of reproduction block closest to said start request position indicated by said start request position information as the transmission start position when said start request position indicated by said start request position information is not coincident with the top of reproduction block.

The 3^{rd} aspect of the present invention is the AV server according to the 1^{st} aspect of the present invention, wherein said transmitting means transmits the transmission start position information that is the information indicating said transmission start position.

The 4^{th} aspect of the present invention is the AV server according to the 1^{st} aspect of the present invention, wherein said reproduction request received by said reproduction request receiving means has the end request position information that is the information indicating the end request position designating at which position to end the reproduction for the AV content identified by said AV content identifier,

said transmit data determining means obtains the request size from said start request position indicated by said start request position information and said end request position indicated by said end request position information, and determines the transmission position so that the transmit data amount is less than or equal to said request size, and the end of transmit data is matched with the end of anyone of said reproduction blocks, and

said transmitting means transmits said AV content in a range from said transmission start position to said transmission end position.

The 5^{th} aspect of the present invention is the AV server according to the 1^{st} aspect of the present invention, wherein said reproduction request received by said reproduction request receiving means further has the request size information that is the information indicating the request size, said transmit data determining means determines the transmission end position so that the transmit data amount is less than or equal to said request size, and the end of transmit data is matched with the end of anyone of said reproduction blocks, and said transmitting means transmits said AV content in a range from said transmission start position to said transmission end position.

The 6^{th} aspect of the present invention is the AV server according to the 4^{th} aspect of the present invention, wherein said transmitting means further transmits the transmission end position information that is the information indicating said transmission end position.

The 7^{th} aspect of the present invention is the AV server according to the 5^{th} aspect of the present invention, wherein said transmitting means further transmits the transmission end position information that is the information indicating said transmission end position.

The 8^{th} aspect of the present invention is the AV server according to the 1^{st} aspect of the present invention, wherein said AV contents are an MPEG video, and each of said reproduction blocks is GOP.

The 9^{th} aspect of the present invention is the AV server according to the 1^{st} aspect of the present invention, wherein said AV contents are DVD-VR formatted video, and each of said reproduction blocks is VOBU.

The 10^{th} aspect of the present invention is an AV contents reproducing apparatus comprising:

user input means of accepting the input having an AV content identifier that is the information for identifying the AV content;

received data determining means of determining the start request position designating from which position to start the reproduction for the AV contents identified by said AV content identifier accepted by said user input means;

reproduction request transmitting means of transmitting said AV content identifier and a reproduction start request containing the start request position information that is the information indicating said start request position;

receiving means of receiving the AV content as a response to said reproduction start request; and

reproducing means of reproducing the AV content received by said receiving means;

wherein said receiving means receives said AV content and the transmission end position information that is the information indicating the transmission end position designating to which position to contain data in said AV content; and

wherein said received data determining means determines the start request position designating from which position to start the reproduction in said AV content identified by the AV content identifier accepted by said user input means, based on said received transmission end position information.

The 11^{th} aspect of the present invention is an AV transmitting method comprising:

a store step of holding one or more AV content containing video, image and/or audio and composed of a plurality of reproduction blocks;

a reproduction request receiving step of receiving an AV content identifier that is the information for identifying the AV content and a reproduction request having the start request position information that is the information indicating the start request position designating from which position to start the reproduction for the AV content identified by said AV content identifier;

a transmit data determining step of determining the top of reproduction block as the transmission start position when said start request position information is coincident with the top of reproduction block, or determining the top of reproduction block before or after said start request position indicated by said start request position information as the transmission start position when said start request position information is not coincident with the top of reproduction block; and

a transmission step of transmitting the AV content identified by said AV content identifier provided in said reproduction request received by said reproduction request receiving means from said transmission start position.

The 12^{th} aspect of the present invention is a program for enabling a computer to function as the AV server according to the st aspect of the present invention, said AV server comprising:

store means of holding one or more AV contents containing video, image and/or audio and composed of a plurality of reproduction blocks;

reproduction request receiving means of receiving an AV content identifier that is the information for identifying the AV content and a reproduction request having the start request position information that is the information indicating the start request position designating from which position to start the reproduction for the AV content identified by said AV content identifier;

transmit data determining means of determining the top of reproduction block as the transmission start position when said start request position information is coincident with the top of reproduction block, or determining the top of reproduction block before or after said start request position indicated by said start request position information as the transmission start position when said start request position information is not coincident with the top of reproduction block; and

transmitting means of transmitting the AV content identified by said AV content identifier provided in said reproduction request received by said reproduction request receiving means from said transmission start position.

The 13^{th} aspect of the present invention is a computer readable recording medium recording the program according to the 12^{th} aspect of the present invention.

The 14^{th} aspect of the present invention is an AV server comprising:

store means of holding one or more AV contents containing video, image and/or audio and composed of a plurality of reproduction blocks;

reproduction request receiving means of receiving an AV content identifier that is the information for identifying the AV content and a reproduction request having the start request position information that is the information indicating the start request position designating from which position to start the reproduction for the AV content identified by said AV content identifier;

transmit data determining means of determining the top of reproduction block before said start request position indicated by said start request position information as the transmission start position; and

transmitting means of transmitting the AV content identified by said AV content identifier provided in said reproduction request received by said reproduction request receiving means from said transmission start position.

The 15^{th} aspect of the present invention is an AV server comprising:

store means of holding one or more AV contents containing video, image and/or audio and composed of a plurality of reproduction blocks;

reproduction request receiving means of receiving an AV content identifier that is the information for identifying the AV content and a reproduction request having the start request position information that is the information indicating the start request position designating from which position to start the reproduction for the AV content identified by said AV content identifier;

transmit data determining means of determining the top of reproduction block after said start request position indicated by said start request position information as the transmission start position; and

transmitting means of transmitting the AV content identified by said AV content identifier provided in said reproduction request received by said reproduction request receiving means from said transmission start position.

The 16^{th} aspect of the present invention is an AV server comprising:

store means of holding one or more AV contents containing video, image and/or audio and composed of a plurality of reproduction blocks;

reproduction request receiving means of receiving an AV content identifier that is the information for identifying the AV content and a reproduction request having the end request position information that is the information indicating the end request position designating at which position to end the reproduction for the AV content identified by said AV content identifier;

transmit data determining means of determining the end of reproduction block after said end request position indicated by said end request position information as the transmission end position; and

transmitting means of transmitting the AV content identified by said AV content identifier provided in said reproduction request received by said reproduction request receiving means up to said transmission end position.

The 17^{th} aspect of the present invention is an AV server comprising:

store means of holding one or more AV contents containing video, image and/or audio and composed of a plurality of reproduction blocks;

reproduction request receiving means of receiving an AV content identifier that is the information for identifying the AV content and a reproduction request having the end request position information that is the information indicating the end request position designating at which position to end the reproduction for the AV content identified by said AV content identifier;

transmit data determining means of determining the end of reproduction block before said end request position indicated by said end request position information as the transmission end position; and

transmitting means of transmitting the AV content identified by said AV content identifier provided in said reproduction request received by said reproduction request receiving means up to said transmission end position.

The 18^{th} aspect of the present invention is an AV server comprising:

store means of holding one or more AV contents containing video, image and/or audio and composed of a plurality of reproduction blocks;

reproduction request receiving means of receiving an AV content identifier that is the information for identifying the AV content and a reproduction request having the start request position information that is the information indicating the start request position designating from which position to start the reproduction for the AV content identified by said AV content identifier;

transmit data determining means of determining the top of reproduction block as the transmission start position when said start request position indicated by said start request position information is coincident with the top of reproduction block, or determining the top of reproduction block before said start request position indicated by said start request position information as the transmission start position when said start request position indicated by said start request position information is not coincident with the top of reproduction block; and

transmitting means of transmitting the AV content identified by said AV content identifier provided in said reproduction request received by said reproduction request receiving means from said transmission start position.

The 19^{th} aspect of the present invention is an AV server comprising:

store means of holding one or more AV contents containing video, image and/or audio and composed of a plurality of reproduction blocks;

reproduction request receiving means of receiving an AV content identifier that is the information for identifying the AV content and a reproduction request having the start request position information that is the information indicating the start request position designating from which position to start the reproduction for the AV content identified by said AV content identifier;

transmit data determining means of determining the top of reproduction block as the transmission start position when said start request position indicated by said start request position information is coincident with the top of reproduction block, or determining the top of reproduction block after said start request position indicated by said start request position information as the transmission start position when said start request position indicated by said start request position information is not coincident with the top of reproduction block; and

transmitting means of transmitting the AV content identified by said AV content identifier provided in said reproduction request received by said reproduction request receiving means from said transmission start position.

The 20^{th} aspect of the present invention is an AV server comprising:

store means of holding one or more AV contents containing an image and/or a voice and composed of a plurality of reproduction blocks;

reproduction request receiving means of receiving an AV contents identifier that is the information for identifying the AV contents and a reproduction request having the end request position information that is the information indicating the end request position designating at which position to end the reproduction for the AV contents identified by said AV contents identifier;

transmit data determining means of determining the end of reproduction block as the transmission end position when said end request position indicated by said end request position information is coincident with the end of reproduction block, or determining the end of reproduction block after said end request position indicated by said end request position information as the transmission end position when said end request position indicated by said end request position information is not coincident with the end of reproduction block; and

transmitting means of transmitting the AV content identified by said AV content identifier provided in said reproduction request received by said reproduction request receiving means up to said transmission end position.

The 21^{st} aspect of the present invention is an AV server comprising:

store means of holding one or more AV contents containing video image and/or audio and composed of a plurality of reproduction blocks;

reproduction request receiving means of receiving an AV content identifier that is the information for identifying the AV content and a reproduction request having the end request position information that is the information indicating the end request position designating at which position to end the reproduction for the AV content identified by said AV content identifier;

transmit data determining means of determining the end of reproduction block as the transmission end position when said end request position indicated by said end request position information is coincident with the end of reproduction block, or determining the end of reproduction block before said end request position indicated by said end request position information as the transmission end position when said end request position indicated by said end request position information is not coincident with the end of reproduction block; and

transmitting means of transmitting the AV content identified by said AV content identifier provided in said reproduction request received by said reproduction request receiving means up to said transmission end position.

The present invention includes of the first to fourteenth inventions as follows.

That is, a network reproducing method of the first invention comprises a reproduction request step of enabling the AV content reproducing apparatus to transmit an AV content identifier for identifying the AV content and a reproduction start request having the start request position information to an AV server. Also, it comprises a transmit data determining step of enabling the AV server to receive this reproduction start request, and determine the top of reproduction block near the specified start request position as the transmission start position. Moreover, it comprises a transmission step of enabling the AV server to transmit the specified AV content from the transmission start position. Moreover, it comprises a step for AV contents reproducing apparatus to receive the AV content transmitted at the transmission step. Thereby, the AV contents reproducing apparatus is allowed to reproduce the AV content from the top of reproduction block via the network without having the correct information concerning the position of reproduction block.

Also, the network reproducing method of the second invention further comprises transmitting the transmission start position information at the transmission step in the network reproducing method according to the first invention. Thereby, the AV contents reproducing apparatus can estimate the top of reproduction block to be requested at the next time from the received transmission start position and data size, and specify the correct reproduction start position upon the next reproduction start request. This eliminates the need for the AV server to find the top of reproduction block near the start request position, reducing the load on the AV server.

Also, the network reproducing method of the third invention is the network reproducing method according to the first or second invention wherein the reproduction start request further contains the request size information that is the information indicating the request size. Also, at the transmit data determining step, the AV server determines the transmission end position so that the transmit data amount is less than or equal to the request size and the end of transmit data is matched with the end of any one of the reproduction blocks, and at the transmission step, the specified AV content is transmitted from the transmission start position to the transmission end position. Thereby, the AV contents reproducing apparatus can receive data of the AV content in accordance with the empty state of the buffer assigned for reception.

Also, the network reproducing method of the fourth invention is the network reproducing method according to the first or second invention wherein the reproduction start request transmitted by the AV contents reproducing apparatus contains the end request position information indicating the end request position designating up to which position of the AV content should be transmitted. Also, at the transmit data determining step, the AV server determines, as the transmission end position, the position at which the end of transmit data is matched with the end of any one of the reproduction blocks, and which is not beyond the end request position, and at the transmission step, the specified AV content is transmitted from the transmission start position to the transmission end position. Thereby, the AV contents reproducing apparatus can receive data of the AV contents in accordance with the empty state of the buffer assigned for reception. The load on the AV server for size calculation is reduced compared to the method of the third invention.

The network reproducing method of the fifth invention is the network reproducing method according to the third or fourth invention wherein at the transmission step, the AV server further transmits the transmission end position information. Thereby, the AV contents reproducing apparatus can easily find the top of reproduction block to be reproduced at the next time, and specify the correct reproduction start position upon the next reproduction start request. This eliminates the need for the AV server to find the top of reproduction block near the start request position, reducing the load on the AV server.

The network reproducing method of the sixth invention is the network reproducing method according to the fifth invention wherein the AV contents reproducing apparatus receives the transmission end position information and determines the top of reproduction block and the start request position information based on the received transmission end position information in transmitting the next reproduction start request. Thereby, the correct reproduction start position is specified upon the reproduction start request. This eliminates the need for the AV server to find the top of reproduction block near the start request position, reducing the load on the AV server.

The network reproducing method of the seventh invention is the network reproducing method according to any one of the first to sixth inventions wherein the AV content involves MPEG video, and each of the reproduction blocks is GOP. Thereby, in the case of the MPEG video, the AV contents reproducing apparatus reproduces the AV contents in a unit of GOP.

The network reproducing method of the eighth invention is the network reproducing method according to any one of the first to sixth inventions wherein the AV content involves DVD-VR formatted video, and each of the reproduction blocks is VOBU. Thereby, in the case of the DVD-VR formatted video, the AV contents reproducing apparatus reproduces the AV content in a unit of VOBU.

The network reproducing method of the ninth invention is the network reproducing method according to any one of the first to eighth inventions wherein transmission and reception between the AV server and the AV contents reproducing apparatus are based on HTTP. Thereby, the effects of the first to eighth inventions are achieved in accordance with the standard protocol.

The network reproducing method of the tenth invention is the network reproducing method according to any one of the first to ninth inventions wherein transmission and reception between the AV server and the AV contents reproducing apparatus are based on HTTP, and the start request position information is recorded in the X-Range header. Thereby, the effects of the first to ninth inventions are achieved in accordance with the standard protocol and employing the header extended in standardized way.

The network reproducing method of the eleventh invention is the network reproducing method according to the second invention wherein transmission and reception between the AV server and the AV contents reproducing apparatus are based on HTTP, and the transmission start position information is recorded in the X-Content-Range header of HTTP. Thereby, the effect of the second invention is achieved in accordance with the standard protocol and employing the header extended in standardized way.

The network reproducing method of the twelfth invention is the network reproducing method according to the fourth invention wherein transmission and reception between the AV server and the AV contents reproducing apparatus are based on HTTP, and the end request position information is recorded in the X-Range header of HTTP. Thereby, the effect of the fourth invention is achieved in accordance with the standard protocol and employing the header extended in standardized way.

The network reproducing method of the thirteenth invention is the network reproducing method according to the fifth invention wherein transmission and reception between the AV server and the AV contents reproducing apparatus are based on HTTP, and the transmission start position information and the transmission end position information are recorded in the X-Content-Range header of HTTP. Thereby, the effect of the fifth invention is achieved in accordance with the standard protocol and employing the header extended in standardized way.

The network reproducing method of the fourteenth invention is the network reproducing method according to any one of the first to thirteenth inventions wherein the position in the AV content is specified in terms of the time information. Thereby, the effects of the first to thirteenth inventions are achieved with the AV contents reproducing apparatus managing the reproduction of the AV content in terms of the time. At present, the position in the X-Range header and the X-Content-Range header is specified only in terms of the byte value, whereby when the position is specified in terms of the time information, an extension header must be employed. It is more effective when the X-Range header and the Content-Length header can deal with the time information in the future.

### BRIEF DESCRIPTION OF THE DRAWINGS

FIG. 1 is a configuration diagram of a network to which one embodiment of the present invention is applied;

FIG. 2 is a sequence diagram describing the transmission and reception between the AV server and the AV contents reproducing apparatus;

FIG. 3 is a diagram showing the organization of prog.vob taken as an example of the AV content in FIG. 2;

FIG. 4 is a block diagram showing the configuration of the AV server;

FIG. 5 is a flowchart showing the operation of the AV server;

FIG. 6 is a block diagram showing the configuration of the AV contents reproducing apparatus;

FIG. 7 is a flowchart showing the operation of the AV contents reproducing apparatus;

FIG. 8(a) is a diagram between the start request position and the determined transmission start position in a first variant example;

FIG. 8(b) is a diagram between the start request position and the determined transmission start position in a second variant example;

FIG. 8(c) is a diagram between the end request position and the determined transmission end position in a third variant example;

FIG. 8(d) is a diagram between the end request position and the determined transmission end position in a fourth variant example;

FIG. 9(a) is a diagram between the start request position and the determined transmission start position in a fifth variant example;

FIG. 9(b) is a diagram between the start request position and the determined transmission start position in a sixth variant example;

FIG. 9(c) is a diagram between the end request position and the determined transmission end position in a seventh variant example;

FIG. 9(d) is a diagram between the end request position and the determined transmission end position in an eighth variant example;

FIG. 10(a) is a diagram showing one example of the correspondence table that the conventional AV server transmits to the conventional AV contents reproducing apparatus; and

FIG. 10(b) is a diagram showing another example of the correspondence table that the conventional AV server transmits to the conventional AV contents reproducing apparatus.

### DESCRIPTION OF SYMBOLS

1 AV server
11 Store means
12 Reproduction request means
13 Transmit data determining means
14 Transmitting means
2 AV contents reproducing apparatus
21 User input means
22 Received data determining means
23 Reproduction request transmitting means
24 Receiving means
25 Buffer
26 Reproducing means
3 Network

### PREFERRED EMBODIMENTS OF THE INVENTION

The preferred embodiments of the present invention will be described below with reference to the accompanying drawings.

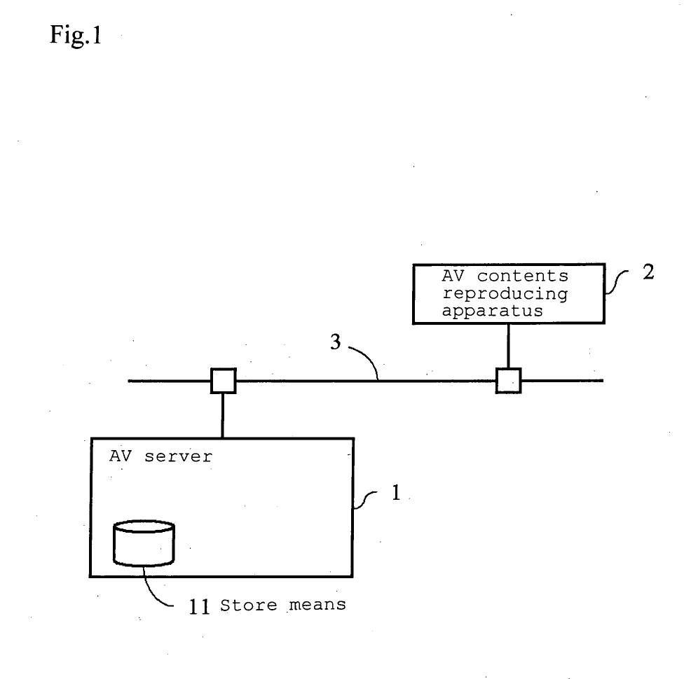

FIG. 1 is a configuration diagram of a network to which one embodiment of the present invention is applied. An AV server 1 transmits the AV content recorded in store means 11 to the network 3 upon a request from an AV contents reproducing apparatus 2. The AV contents reproducing apparatus 2 receives and reproduces the AV content from the AV server 1. The AV content here is data including video, image, audio, or all of them, and composed of a plurality of reproduction blocks. In this embodiment, one example of the AV content is DVD-VR formatted video, and the name of the DVD-VR formatted video that the AV contents reproducing apparatus 2 requests to transmit is supposed as “prog.vob”.

The operation of the AV server 1 and the AV contents reproducing apparatus 2 in this embodiment will be outlined below.

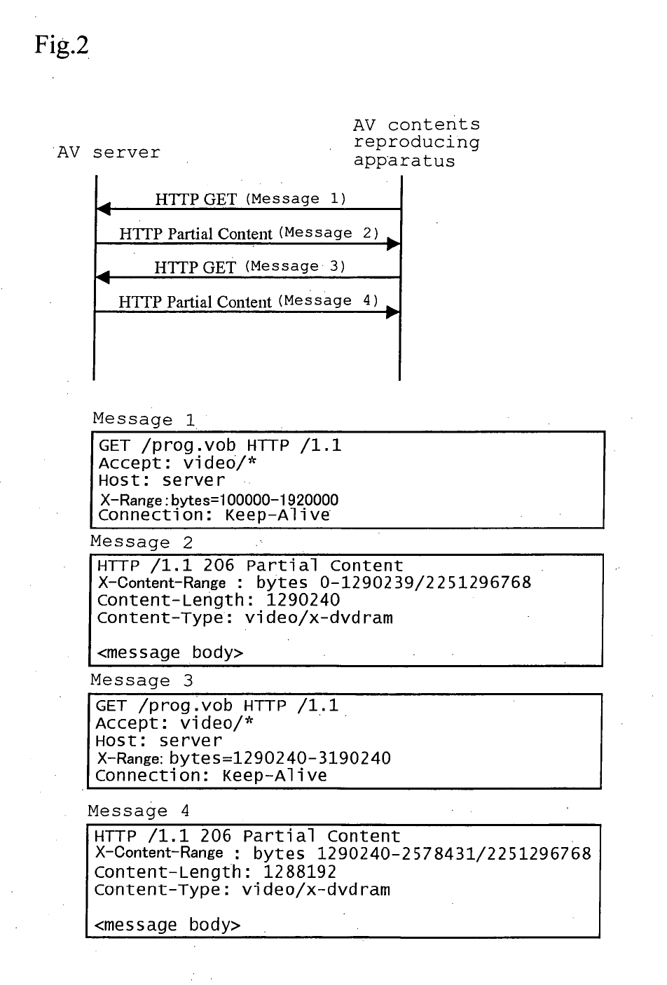

FIG. 2 is a sequence diagram describing transmission and reception between the AV server 1 and the AV contents reproducing apparatus 2. In this embodiment, an HTTP protocol is employed for the transmission and reception. However, it does not matter whether any transmission and reception protocol is employed. FIG. 2 is an example in which the AV contents reproducing apparatus 2 reproduces prog.vob recorded in the store means 11 of the AV server 1 from the top of video via the network.

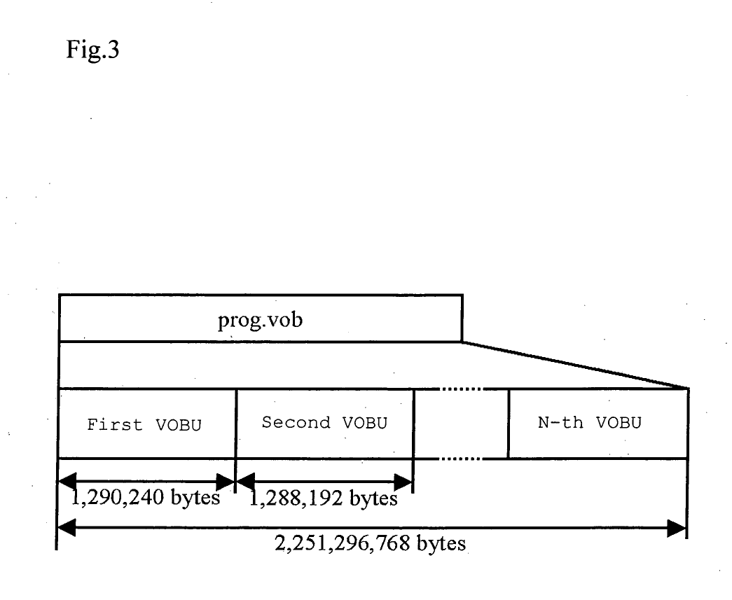

FIG. 3 illustrates the organization of prog.vob. prog.vob has a total size of 2251296768 bytes, and is composed of N VOBUs (Video Object Units). The length of the first VOBU is 1290240 bytes, and the length of the second VOBU is 1288192 bytes. VOBU is an example of reproduction block. Namely, the reproduction block may have another structure, and any data size. Also, the store means 11 is suitably a non-volatile recording medium such as a hard disk, but may be realized with a volatile recording medium.

In FIG. 2, the AV contents reproducing apparatus firstly transmits a message 1 of reproduction start request to the AV server 1. The message 1 contains an X-Range header for requesting to transmit data in a range from byte 100000 to byte 1920000 of prog.vob. The X-Range header is an HTTP extension header for notifying a requested range of data. The start request position is byte 100000 and the end request position is byte 1920000. Herein, the start request position information that is the information indicating the start request position is “100000”, and the end request position information that is the information indicating the end request position is “1920000′”. Also, the start request position information and the end request position information is recorded in the X-Range header of HTTP.

If the AV server 1 receives this message 1, it transmits a message 2. The message 2 contains an X-Content-Range header, indicating to transmit from byte 0 to byte 1290239 of prog.vob as requested. The X-Content-Range header is an HTTP extension header for notifying a transmission range of data. The transmission start position is byte 0, and the transmission end position is byte 1290239. And the transmission start position information that is the information indicating the transmission start position is “0”, and the transmission end position information that is the information indicating the transmission end position is “1290239”. Also, the transmission start position information and the transmission end position information are recorded in the X-Content-Range header of HTTP.

Herein, apart from byte 0 to byte 1290239 constitutes the first VOBU (Video OBject Unit) of prog.vob. Though the AV server 1 is requested to transmit data in a range from byte 100000 to byte 1920000 of prog.vob, byte 100000 from the top of prog.vob corresponds to halfway data position of VOBU, and is not coincident with the delimiter of VOBU. Accordingly, the AV server 1 transmits data from byte 0 that is located before byte 100000 from the top of prog.vob and at the delimiter of VOBU. Though the AV server 1 is requested to transmit a range from byte 100000 to byte 1920000, it transmits data up to byte 1290239 at the delimiter of VOBU not beyond 1920000.

That is, the AV server 1 determines, as the transmission start position, the position at which the start of transmit data is the start of reproduction block and which is at the top of reproduction block closest to the start request position indicated by the received start request position information. In addition, the transmission end position is determined so that the data size may be less than or equal to that obtained from the start request position indicated by the received reproduction request position information and the end request position indicated by the received end request position information, and the end of transmit data may be matched with the end of reproduction block. And the AV server 1 transmits data in a range from byte 0 determined as the transmission start position to byte 1290239 determined as the transmission end position.

Also, it is indicated that the total size of prog.vob is 2251296768 bytes, following “/” of the X-Content-Range header provided in the message 2 transmitted from the AV server 1. In a message body of the message 2, the first VOBU (i.e., from byte 0 to byte 1290239) of prog.vob is stored, and transferred from the AV server 1 to the AV contents reproducing apparatus 2.

If transfer of the first VOBU is completed, the AV contents reproducing apparatus 2 transmits a message 3. The message 3, like the message 1, contains the X-Range header. It is requested to transmit data in a range from byte 1290240 to byte 3190240 of prog.vob this time. Byte 1290240 corresponds to the next byte of the end point 1290239 indicated in the X-Content-Range header of the message 2. Namely, the AV contents reproducing apparatus 2 determines the next start request position, based on the transmission end position information. The AV contents reproducing apparatus 2 normally determines the “transmission end position information +1” as the start request position information indicating the next start request position, but may determine the next start request position information by other methods.

In response to the message 3, the AV server 1 transmits a message 4 to the AV contents reproducing apparatus 2. The message 4 also contains the X-Content-Range header, indicating the transmission of data from byte 1290240 to byte 2578431. This constitutes the second VOBU. The above procedure is repeated until all prog.vob is transmitted.

Thus, the configuration and operation of the AV server 1 and the AV contents reproducing apparatus 2 have been outlined above.

The AV server 1 of this embodiment will be described below in detail.

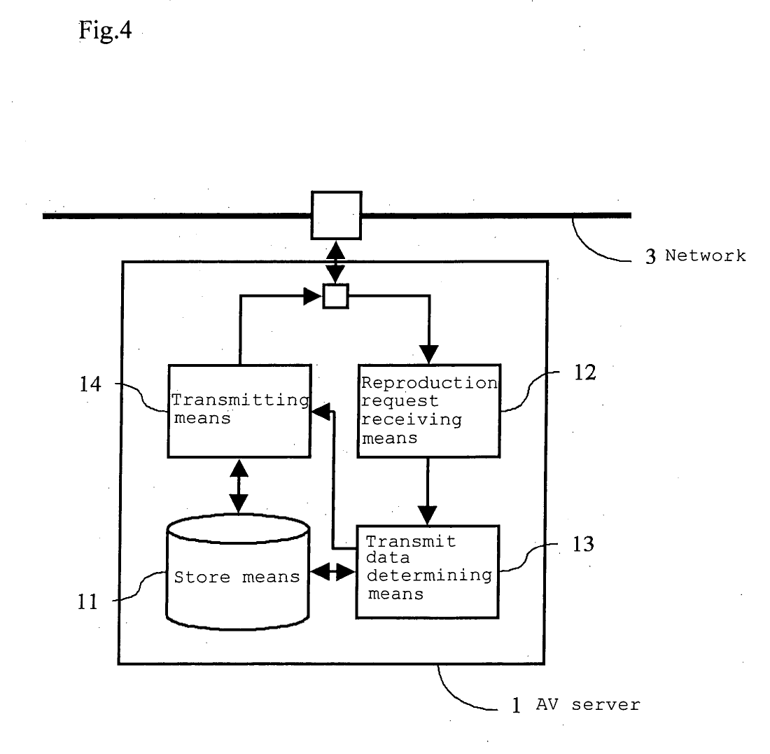

FIG. 4 is a block diagram showing the configuration of the AV server 1 in this embodiment. In FIG. 4, the store means 11 is means of storing one or more DVD-VR formatted video. Reproduction request receiving means 12 is means of receiving a reproduction start request from the AV contents reproducing apparatus 2 via the network 3. The reproduction start request has an AV content identifier that is the information for identifying the AV content and the start request position information that is the information indicating the start request position designating from which position to start the reproduction for the AV content identified by the AV content identifier.

Transmit data determining means 13 is means of determining the transmission start position and the transmission end position from the received reproduction start request. Transmitting means 14 is means of transmitting the DVD-VR formatted video designated by the reproduction start request from the transmission start position to the transmission end position to the AV contents reproducing apparatus 2, and transmitting the transmission start position information indicating the transmission start position and the transmission end position information indicating the transmission end position. The reproduction request receiving means 12 and the transmit data determining means 13 may be realized by wireless or wire communication means.

The operation of the AV server 1 in this embodiment will be described below in detail.

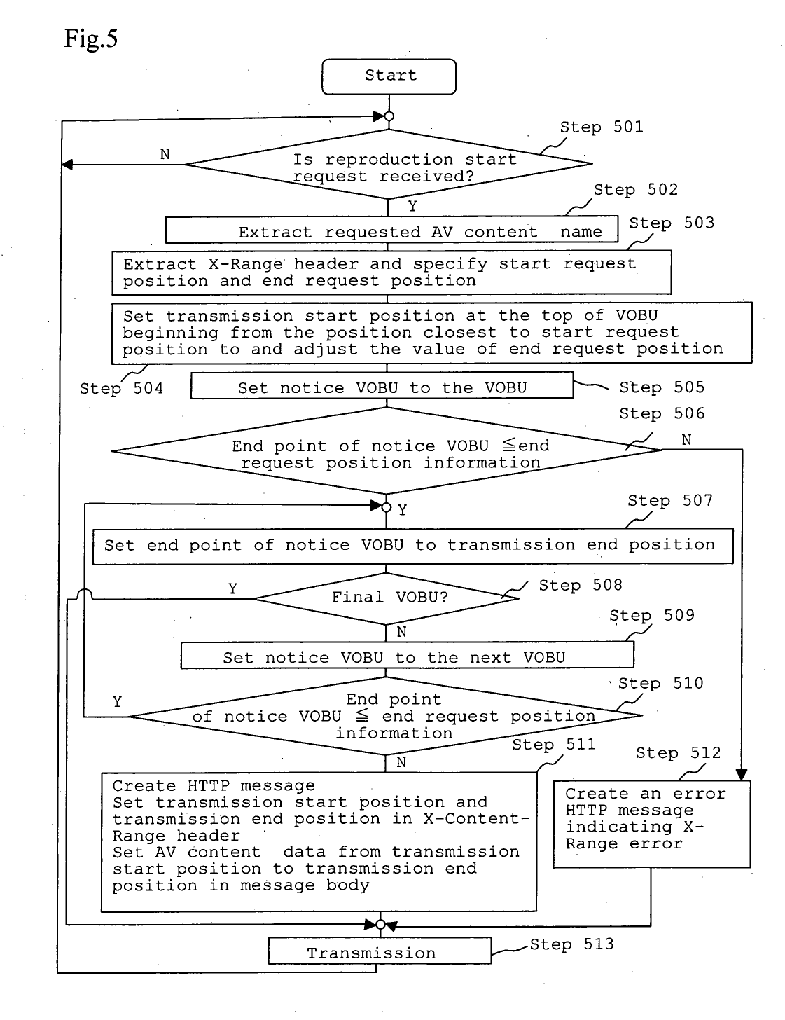

FIG. 5 is a flowchart showing the operation of the AV server 1 in this embodiment. Referring to FIG. 5, the operation of the AV server 1 in accordance with the sequence of FIG. 2 will be described.

If the reproduction request receiving means 12 of the AV server 1 receives an HTTP message (including a GET method, message 1 or 3 of FIG. 2) that is a reproduction start request (step 501), this HTTP message is passed to the transmit data determining means 13.

The transmit data determining means 13 extracts the name (prog.vob in FIG. 2) of the AV content requested to transmit from URI designated by the GET method (step 502), and also extracts the start request position information and the end request position information from the X-Range header (step 503). Then, the transmit data determining means 13 selects VOBU (near the start request position) beginning from the position closest to the extracted start request position from among the VOBUs composing the requested AV content, seeing the store means 11, and sets its top of VOBU to the transmission start position (inputs a value into the transmission start position information) (step 504). If the extracted start request position is coincident with the top of VOBU, the position of the coincident top of VOBU is set to the transmission start position, or if the extracted start request position is not coincident with the top of VOBU, the position of the top of VOBU before or after the extracted start request position is set to the transmission start position.

That is, when the transmission start position is different from the start request position, the end request position value (end request position information) is adjusted. For example, if the transmission start position is larger by X bytes than the start request position, the value of the received end request position information plus X bytes is employed as the subsequent end request position information. Byte 0 in the message 1 and byte 1290240 in the message 3 are selected in FIG. 2. (In FIG. 2, because the transmission of data from the top of prog.vob is requested, the start request position is coincident with the top of VOBU upon the first reproduction start request, but, for example, when a range from byte 1200000 to byte 2500000 is specified in the X-Range header of the message 1, the second VOBU beginning from the position closest to byte 1200000 is selected, and the transmission start position is byt. 1290240.)

Then, the transmit data determining means 13 compares the value indicating the end point of this VOBU and the end request position information (steps 505, 506). If the value indicating the end point of VOBU is equal to or less than the end request position information, the value indicating the end point of VOBU is set to the transmission end position information (step 507). Then, the transmit data determining means 13 checks whether or not the VOBU of which the end position is checked at step 506 is the final VOBU composing the requested AV contents (step 2508), and if not, compares the value indicating the end point of the next VOBU and the end request position information (steps 509, 510). If the value indicating the end point of VOBU is equal to or less than the end request position information, the procedure returns to step 507 to set up the value indicating the endpoint to the transmission end position information. The operation from step 507 to step 510 is repeated while the value indicating the end point of noticed VOBU is less than or equal to the value indicated by the end request position information, and the VOBU is not the final VOBU composing the AV content.

In this way, if the transmission start position and the transmission end position are determined, the transmit data determining means 13 notifies the transmitting means 14 of the transmission start position information and the transmission end position information. The transmitting means 14 creates an HTTP message having the X-Content-Range header recording the transmission start position information and the transmission end position information and the message body containing from the transmission start position to the transmission end position of the requested AV content, and transmits it to the network 3 (steps 511, 513). This HTTP message is the message 2 or message 4 in the example of FIG. 2. Since the transmit data of the AV content is contained in the store means 11, the transmitting means 14 acquires needed data from the store means 11 when transmitting the HTTP message.

As a result of determination at step 506, if the value indicating the end point of VOBU is greater than the end request position information, the transmit data determining means 13 considers that the AV contents reproducing apparatus 2 has less enough buffer to receive the VOBU and notifies the transmitting means 14 to that effect. The transmitting means 14 creates an HTTP message indicating an X-Range error, and transmits it to the network 3 (steps 512, 513).

The configuration and operation of the AV server 1 were described above in detail.

The AV contents reproducing apparatus 2 will be described in detail.

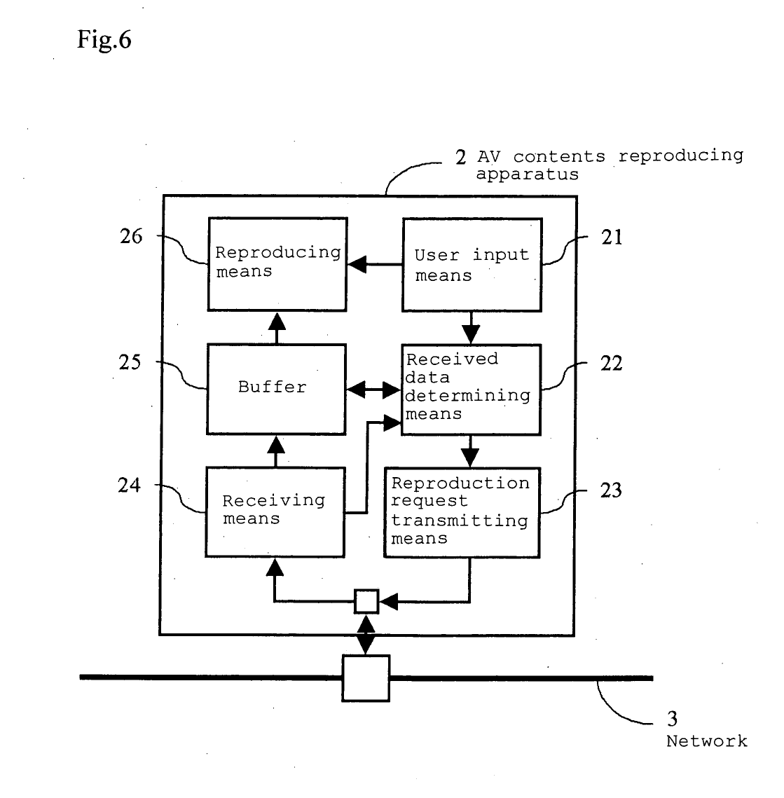

FIG. 6 is a block diagram showing the configuration of the AV contents reproducing apparatus 2 in this embodiment. In FIG. 6, user input means 21 is means of accepting the AV contents identifier (name, etc.) that is the information for identifying the AV contents for network reproduction or a reproduction start request or stop request from the user. Specifically, the user input means 21 is means of accepting the AV content identifier and the time information (e.g., 30 minutes (meaning to start the operation after 30 minutes)). The user input means 21 may only accept the input (information) of the AV content identifier. Input means of the information accepted by the user input means 21 may be a ten key, a keyboard, a mouse or a remote controller for operating a menu screen. The user input means 21 may be realized by a device driver of the input means such as ten key or keyboard, or the control software for the menu screen.

Received data determining means 22 is means of receiving a notification from the user input means 21, an inquiry result regarding the empty capacity of a buffer 25, and a notification from receiving means 24 and determining the start request position and the end request position. The received data determining means 22 may determine the start request position from which the reproduction for the AV content is requested to start, only based on a notification from the user input means 21.

Also, the received data determining means 22 may possibly determine the next start request position, based on the transmission start position information and the size of the received AV content.

Also, when receiving means 24 receives the AV content and the transmission end position information indicating up to which position of the AV content is contained, the received data determining means 22 may determine the next start request position from the received transmission end position information in some cases. The details of such processing will be described later. The received data determining means 22 may be usually realized by an MPU or memory. A processing procedure of the received data determining means 22 is usually implemented by software, and its software is stored in a recording medium such as ROM. However, it may be implemented by hardware (special circuit).

Reproduction request transmitting means 23 is means of creating a reproduction start request including an AV contents identifier for requesting the network reproduction and the start request position information and the end request position information and transmitting it to the network 3. The start request position information and the end request position information may be determined based on the information accepted by the user input means 21, an inquiry result regarding the empty capacity of the buffer 25 and a notification from the receiving means 24. The reproduction start request may include the AV content identifier and the start request position information alone.

The receiving means 24 is means of receiving data of the AV content via the network 3 and passing it to the buffer 25, and notifying the transmission end position information transmitted together to the received data determining means 22. The reproduction request transmitting means 23 and the receiving means 24 may be realized by wireless or wire communication means.

Reproducing means 26 is means of sequentially reading and reproducing data of the AV content from the buffer 25. The reproducing means 26 may or may not comprise an output device such as a display or speaker. The reproducing means 26 may be implemented by the driver software of the output device and the reproduction processing software, or the driver software of the output device, the output device and the reproduction processing software.

The operation of the AV contents reproducing apparatus 2 in this embodiment will be described below.

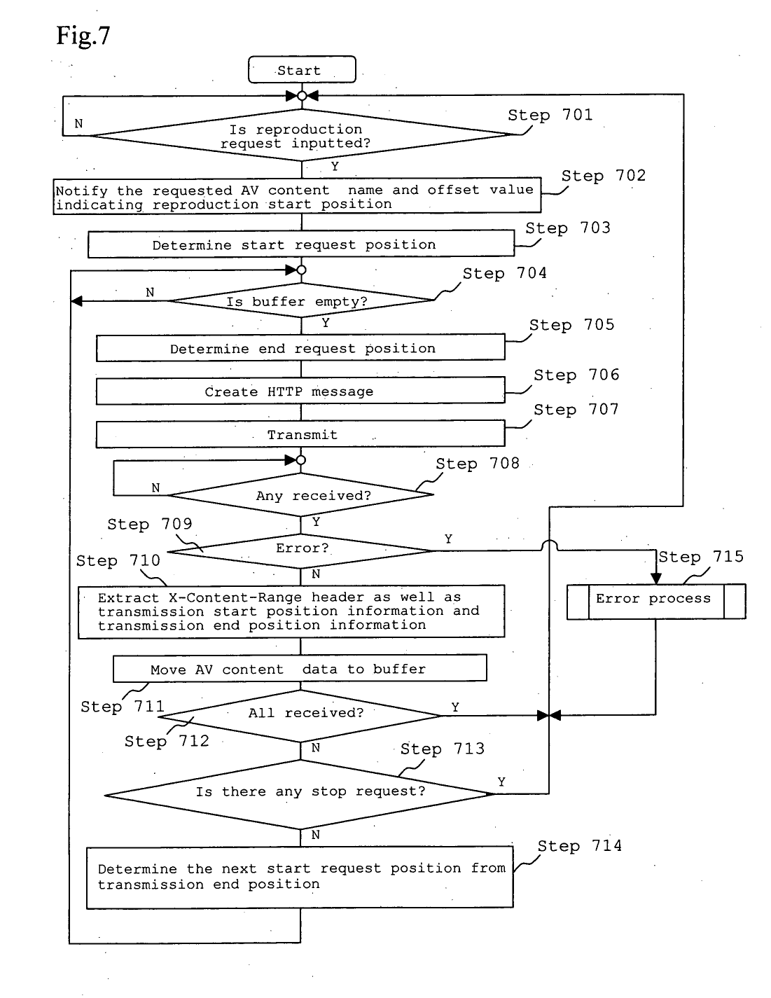

FIG. 7 is a flowchart showing the operation of the AV contents reproducing apparatus 2 in this embodiment. Referring to FIG. 7, the operation of the AV contents reproducing apparatus 2 in accordance with the sequence of FIG. 2 will be described.

If the user input means 21 has a reproduction start request of the AV contents in the AV server 1 (step 701), the user input means 21 notifies the requested AV content identifier (prog.vob in the example of FIG. 2) and an offset value indicating from which position to start the reproduction to the received data determining means 22 (step 702). The offset value notified herein is represented in terms of the time elapsed from the top of the AV content, and has nothing to do with the delimiter of reproduction block such as VOBU. When the reproduction is made from the top of the AV content, the offset value of 0 is notified. The input information (offset value here) indicating the reproduction position is not limited to the time information such as the time elapsed from the top. Also, the input information indicating the reproduction position may have any structure.

The received data determining means 22 calculates the start request position information from the notified offset value (step 703). The received data determining means 22 calculates the start request position information from the notified offset value in accordance with a prepared calculation formula (translating the time information into bytes). For example, the received data determining means 22 calculates a rough value of the start request position information from the average bit rate and the time information. When the bit rate is fixed, the received data determining means 22 can calculate the correct start request position information. The start request position information is represented in terms of the number of bytes from the top of AV content. However, since the AV contents reproducing apparatus 2 does not know the actual relation between the elapsed time and the number of bytes, the accurate value is not attained. Generally, the top of reproduction block such as VOBU is not attained. Then, the received data determining means 22 checks the empty capacity of the buffer 25 (step 704). If the empty capacity is greater than or equal to the maximum value of the preset VOBU length, the end request position information is determined by adding the empty capacity to the start request position information (step 705). The received data determining means 22 notifies a reproduction start request having the requested AV contents name (AV contents identifier), the start request position information and the end request position information to the reproduction request transmitting means 23. At step 705, the end request position information may be determined by adding a certain percentage of the empty capacity to the start request position information. If the empty capacity of the buffer 25 is less than the maximum value of the preset VOBU length, the procedure returns to step 704.

Though in this embodiment, it is described that the start request position information and the end request position information are represented in terms of the number of bytes from the top of AV content, they may be represented in other ways. The start request position information and the end request position information may be represented in terms of the reproduction time from the top of AV content. When the start request position information and the end request position information are represented in terms of the reproduction time from the top of AV contents, the data position is specified more accurately than where the bit rate is not fixed. When the start request position information and the end request position information are represented in terms of the reproduction time from the top of AV content, the AV server 1 can obtain the number of bytes from the top of AV contents, employing the average bit rate.

The reproduction request transmitting means 23 creates an HTTP message containing the start request position information and the end request position information in the X-Range header and requesting to transmit the AV contents of the notified AV contents name (prog.vob) (step 706), and transmits it to the network 3 (step 707). This HTTP message is the message 1 of FIG. 2, for example.

If the receiving means 24 receives an HTTP message that is a response to the transmitted HTTP message from the network 3 (step 708), it is checked whether or not it is an error message (step 709). For the error message, an error processing is performed (step 715), and then the procedure returns to the beginning. Other than the error, the receiving means 24 sends a header part of the HTTP message to the received data determining means 22.

The received data determining means 22 takes the X-Content-Range header out of the header of the received HTTP message, and extracts the transmission start position information and the transmission end position information (step 710). Also, the receiving means 24 sends a message body portion of the HTTP message to the buffer 25 (step 711). Practically, since the size of the HTTP message is greater than the transfer unit for the network 3, it is transferred in plural TCP packets, in which the first TCP packet alone mostly contains the header. Accordingly, the receiving means 24 sends the header to the received data determining means 22 when receiving the first TCP packet, and sequentially sends data of the AV contents incorporated to the buffer 25 when receiving the subsequent TCP packets.

If the received HTTP message reaches the last of the requested AV content (step 712), the procedure returns to the beginning. Otherwise, it is checked whether or not the user input means 21 has a stop request (step 713), and if it has any, the procedure returns to the beginning. If it has no stop request, the received data determining means 22 determines the start request position of the next reproduction start request from the received transmission end position information (sets a value to the start request position information) (step 714). In the normal case, this start request position must be coincident with the top of any VOBU composing the AV content. Then, the procedure returns to step 704, and the above operation is repeated until the last of the AV contents is reached or there is a stop request from the user.

Though not explained in the above, the reproducing means 26 starts to read and reproduce the data, upon a notification of starting the reproduction from the user input means 21, if the data starts to be stored in the buffer 25. A read area of the buffer 25 is usually released successively. When there is a stop notification from the user input means 21 or there is no data in the buffer 25, the reproduction is stopped. Accordingly, at step 704, even if the empty capacity of the buffer 25 is less than the maximum value of the VOBU length, the empty capacity is increased due to reproduction, so that the endless loop is not entered. In the flowchart of FIG. 7, the procedure is ended due to an interruption such as power off or processing end.

Thus, the configuration and operation of the AV contents reproducing apparatus 2 have been described above in detail.

In the present embodiment, when the DVD-VR formatted video recorded in the store means 11 of the AV server 1 is reproduced via the network, the AV contents reproducing apparatus 2 can reproduce the AV content from the top of VOBU even without having the accurate information regarding the VOBU.

Since the AV server 1 transmits, as a response to the first reproduction start request, the transmission end position information indicating the accurate transmission end position to the AV contents reproducing apparatus 2, the AV contents reproducing apparatus 2 can request the reproduction by specifying the top of VOBU for the second or subsequent reproduction start request. In this embodiment, the top of the nearest VOBU is detected at step 504 upon the second or subsequent reproduction start request, but the start request position of the second or subsequent reproduction start request may be the transmission start position, thereby reducing the load on the AV server 1.

Also, besides the start request position, the end request position may be specified as well, whereby the AV contents reproducing apparatus 2 can receive data of the AV content in accordance with the empty situation of the buffer.

As the HTTP extension header, the X-Range header and the X-Content-Range header may be added in conformance with the HTTP standards, employing the HTTP in the transmission and reception between the AV server 1 and the AV contents reproducing apparatus 2, thereby achieving the above effect in accordance with the normal protocol.

Though in the above embodiment, the DVD-VR formatted video is exemplified as the AV content, the same effect is obtained with the same configuration and operation, when reproducing via the network the MPEG video other than in the DVD-VR format. In this case, the reproduction block does not have the unit of VOBU but the unit of GOP (Group of Pictures). Needless to say, the AV content may be in any other format.

Also, in the above embodiment, the AV contents reproducing apparatus 2 requests the AV server 1 for the AV content in a range from byte 100000 to byte 1920000 as the message 1 as shown in FIG. 2, but instead may request the AV server 1 for the AV contents in a range from byte 0 to byte 192000. In this case, since byte 0 is coincident with the top position of VOBU composing the AV content, the AV server 1 transmits, as the message 2 as shown in FIG. 2, the AV contents in a range from byte 0 to byte 1290236 in the same way as in the above embodiment. Also, the AV server 1 performs the subsequent operation in the same way as in the above embodiment.

In the above embodiment, the end request position is specified at the end point of the X-Range header. Alternatively, the request size may be specified, employing the extension header of HTTP. In this case, the transmit data determining means 13 of the AV server 1 treats the result of adding the request size to the start request position as the end request position, and performs the same operation as in the above embodiment.

Also, in the above embodiment, the AV contents reproducing apparatus 2 derives the next request start position from the end point of the X-Content-Range header. Alternatively, it may derive the next request start position from the start point of the X-Content-Range header and the length specified in the Content-Length header.

Also, in the above embodiment, the end request position is specified at the end point of the X-Range header. Alternatively, the request time may be specified, employing the extension header of HTTP. In this case, the transmit data determining means 13 of the AV server 1 treats the result of adding the request time to the start request position as the end request position and calculates the requested number of bytes from the specified request time and the average bit rate of the AV contents, and performs the same operation as in the above embodiment.

Also, in the above embodiment, the AV contents reproducing apparatus 2 derives the next request start position from the end point of the X-Content-Range header. Alternatively, it may derive the next request start position from the start point of the X-Content-Range header and the specified length of time in the Content-Length header.

Also, the request size of the invention may be represented in terms of bytes indicating the amount of data, or the time indicating the reproduction time.

Also, the transmission start position, the transmission end position, the start request position and the end request position of the invention may be represented in terms of bytes indicating the amount of data, or the time indicating the reproduction time from the top of AV content.

Also, in the above embodiment, the transmission start position is set at the coincident top position of VOBU, when the extracted start request position is coincident with the top of VOBU, or set at the top position of VOBU closest to the extracted start request position, when the extracted start request position is not coincident with the top of VOBU. Alternatively, the transmission start position may be set at the coincident top position of VOBU, when the extracted start request position is coincident with the top of VOBU, or set at the top position of VOBU before or after the extracted start request position, when the extracted start request position is not coincident with the top of VOBU.

Moreover, the transmission start data determining means 13 may determine the transmission start position and the transmission end position as in the following variant examples.

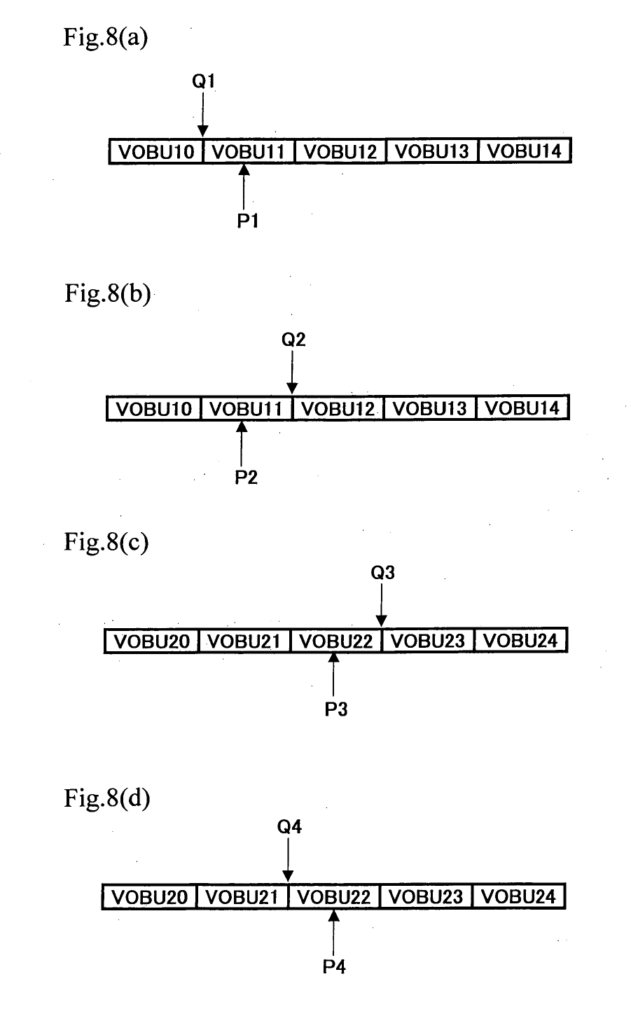

First of all, the first variant example is as follows. That is, the transmit data determining means 13 always determines, as the transmission start position, the top of VOBU before the start request position indicated by the start request position information. That is, irrespective of whether the start request position indicated by the start request position information is coincident with the top position of VOBU or not, the transmission start position is always determined at the top position of VOBU before the start request position. For example, when the start request position indicated by the start request position information is specified at P1 that is the intermediate position of VOBU11, the transmit data determining means 13 determines the transmission start position at the position of Q1 or the top of VOBU11, as shown in FIG. 8(a). In this case, it is desirable that the transmission start position is determined at the top position of VOBU directly before the start request position, but may be determined at the top position of VOBU that is located two or more VOBUs before the start request position.

Also, the second variant example is as follows. That is, the transmit data determining means 13 always determines, as the transmission start position, the top of VOBU after the start request position indicated by the start request position information. That is, irrespective of whether the start request position indicated by the start request position information is coincident with the top position of VOBU or not, the transmission start position is always determined at the top position of VOBU after the start request position. For example, when the start request position indicated by the start request position information is specified at P2 that is the intermediate position of VOBU11, the transmit data determining means 13 determines the transmission start position at the position of Q2, or the end of VOBU11, as shown in FIG. 8(b). In this case, it is desirable that the transmission start position is determined at the top position of VOBU directly after the start request position, but may be determined at the top position of VOBU that is located two or more VOBUs after the start request position.

Also, the third variant example is as follows. That is, the transmit data determining means 13 always determines, as the transmission end position, the top of VOBU after the end request position, indicated by the end request position information. That is, irrespective of whether the end request position indicated by the end request position information is coincident with the end position of VOBU or not, the transmission end position is always determined at the end position of VOBU after the end request position. For example, when the end request position is specified at P3 that is the intermediate position of VOBU22, the transmit data determining means 13 determines the transmission end position at the position of Q3, or the end of VOBU22, as shown in FIG. 8(c). In this case, it is desirable that the transmission end position is determined at the end position of VOBU directly after the end request position, but may be determined at the end position of VOBU that is located two or more VOBUs after the end request position.

Also, the fourth variant example is as follows. That is, the transmit data determining means 13 always determines, as the transmission end position, the top of VOBU before the end request position indicated by the end request position information. That is, irrespective of whether the end request position indicated by the end request position information is coincident with the end position of VOBU or not, the transmission end position is always determined at the end position of VOBU before the end request position. For example, when the end request position indicated by the end request position information is specified at P4 that is the intermediate position of VOBU22, the transmit data determining means 13 determines the transmission end position at the position of Q4, or the top of VOBU22, as shown in FIG. 8(d). In this case, it is desirable that the transmission end position is determined at the end position of VOBU directly before the end request position, but may be determined at the end position of VOBU that is located two or more VOBUs before the end request position.

Also, the transmit data determining means 13 may perform the operation in any combination of the first variant example or the second variant example and the third variant example or the fourth variant example. For example, when the transmit data determining means 13 performs the operation in a combination of the first variant example and the third variant example, data having more than the size of data requested by the AV contents reproducing apparatus 2 may be transmitted. Accordingly, it is required in this case to have a memory for the buffer capable of storing the data having the size a predetermined amount greater than the data size requested by the AV contents reproducing apparatus 2. In other combinations, when the transmit data determining means 13 transmits the data having the size greater than the requested data size, it is required to have a memory for buffer capable of storing the data having the size a predetermined amount greater than the data size requested by the AV contents reproducing apparatus 2.

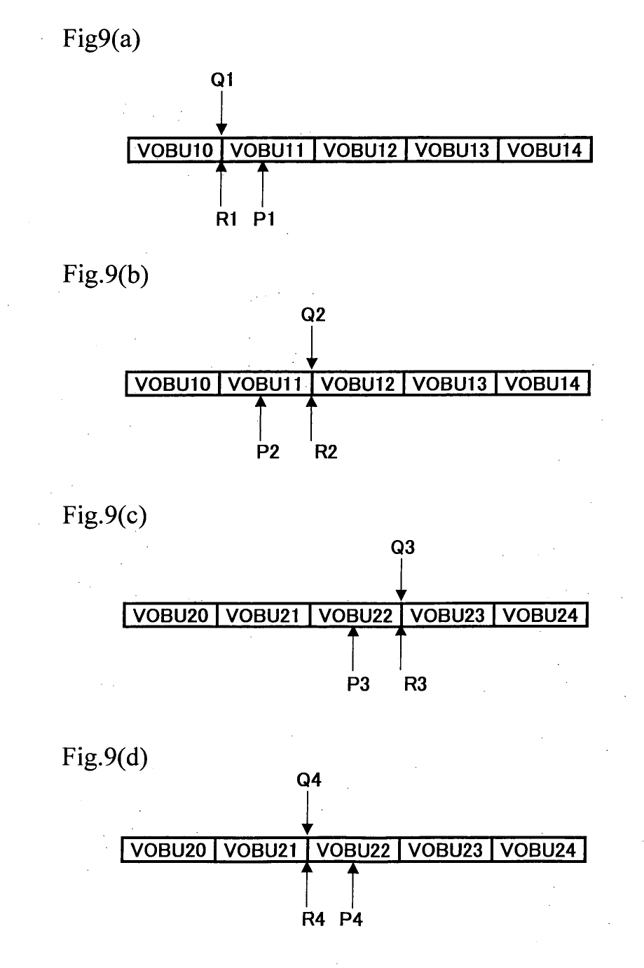

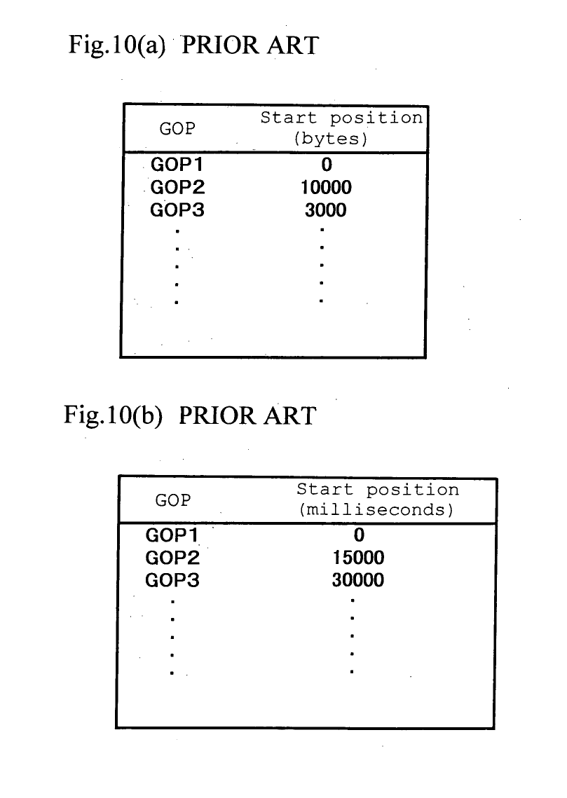

Also, the fifth variant example is as follows. That is, the transmit data determining means 13 determines the top of VOBU as the transmission start position, when the start request position indicated by the start request position information is coincident with the top of VOBU, or determines, as the transmission start position, the top of VOBU before the start request position indicated by the start request position information, when the start request position indicated by the start request position information is not coincident with the top of VOBU. For example, when the start request position indicated by the start request position information is R1 at the top of VOBU11, the transmit data determining means 13 determines the transmission start position at the position of Q1, or the top of VOBU11, as shown in FIG. 9(a), and when the start request position indicated by the start request position information is P1 that is the intermediate position of VOBU11, the transmit data determining means 13 determines the transmission start position at the position of Q1, or the top of VOBU11. In this case, it is desirable that when the start request position indicated by the start request position information is not coincident with the top position of VOBU, the transmission start position is determined at the top position of VOBU directly before the start request position, but may be determined at the top position of VOBU that is located two or more VOBUs before the start request position.

Also, the sixth variant example is as follows. That is, the transmit data determining means 13 determines the top of VOBU as the transmission start position, when the start request position indicated by the start request position information is coincident with the top of VOBU, or determines, as the transmission start position, the top of VOBU after the start request position indicated by the start request position information, when the start request position indicated by the start request position information is not coincident with the top of VOBU. For example, when the start request position indicated by the start request position information is R2 at the top of VOBU12, the transmit data determining means 13 determines the transmission start position at the position of Q2, or the top of VOBU12, as shown in FIG. 9(b), and when the start request position indicated by the start request position information is P2 that is the intermediate position of VOBU11, the transmit data determining means 13 determines the transmission start position at the position of Q2, or the top of VOBU12. In this case, it is desirable that when the start request position indicated by the start request position information is not coincident with the top position of VOBU, the transmission start position is determined at the top position of VOBU directly after the start request position, but may be determined at the top position of VOBU that is located two or more VOBUs after the start request position.

Also, the seventh variant example is as follows. That is, the transmit data determining means 13 determines the end of VOBU as the transmission end position, when the end request position indicated by the end request position information is coincident with the end of VOBU, or determines, as the transmission end position, the end of VOBU after the end request position indicated by the end request position information, when the end request position indicated by the end request position information is not coincident with the end of VOBU. For example, when the start request position indicated by the start request position information is R3 at the end of VOBU22, the transmit data determining means 13 determines the transmission start position at the position of Q3, or the end of VOBU22, as shown in FIG. 9(c), and when the start request position indicated by the start request position information is P3 that is the intermediate position of VOBU22, the transmit data determining means 13 determines the transmission start position at the position of Q3, or the end of VOBU22. In this case, it is desirable that when the end request position indicated by the end request position information is not coincident with the end position of VOBU, the transmission end position is determined at the end position of VOBU directly after the end request position, but may be determined at the end position of VOBU that is located two or more VOBU safer the end request position.

Also, the eighth variant example is as follows. That is, the transmit data determining means 13 determines the end of VOBU as the transmission end position, when the end request position indicated by the end request position information is coincident with the end of VOBU, or determines, as the transmission end position, the end of VOBU before the end request position indicated by the end request position information, when the end request position indicated by the end request position information is not coincident with the end of VOBU. For example, when the start request position indicated by the start request position information is R4 at the end of VOBU21, the transmit data determining means 13 determines the transmission start position at the position of Q4, or the end of VOBU21, as shown in FIG. 9(d), and when the start request position indicated by the start request position information is P4 that is the intermediate position of VOBU22, the transmit data determining means 13 determines the transmission start position at the position of Q4, or the end of VOBU22. In this case, it is desirable that when the end request position indicated by the end request position information is not coincident with the end position of VOBU, the transmission end position is determined at the end position of VOBU directly before the end request position, but may be determined at the end position of VOBU that is located two or more VOBUs before the end request position.

Also, the transmit data determining means 13 may perform the operation in any combination of the fifth variant example or the sixth variant example and the seventh variant example or the eighth variant example. For example, when the transmit data determining means 13 performs the operation in a combination of the fifth variant example and the sixth variant example, data having more than the size of data requested by the AV contents reproducing apparatus 2 may be transmitted. Accordingly, it is required in this case to have a memory for the buffer capable of storing the data having the size a predetermined amount greater than the data size requested by the AV contents reproducing apparatus 2. In other combinations, since the transmit data determining means 13 may transmit the data having the size greater than the requested data size, it is required to have a memory for buffer capable of storing the data having the size a predetermined amount greater than the data size requested by the AV contents reproducing apparatus 2.

The first to eighth variant examples have been described above.

In the above embodiment, a repeater may exist between the AV server and the AV contents reproducing apparatus, in which if the AV contents reproducing apparatus makes a reproduction start request to the repeater, the repeater gains access to the AV server to acquire the AV content and transmits the acquired AV content to the AV contents reproducing apparatus. That is, it is unnecessary for the AV server and the AV contents reproducing apparatus to transmit or receive data directly via the network.

Moreover, the processing of this embodiment may be implemented by software. And this software may be distributed by downloading the software. Also, this software may be recorded and delivered in the recording medium such as CD-ROM. This also applies to other embodiments in this specification. The software for implementing the AV contents reproducing apparatus of this embodiment is the following program. Namely, this program enables a computer to perform an input step of accepting an input having the AV content identifier, a decision step of determining the start request position that is the reproduction position of the AV content, a transmission step of transmitting a reproduction start request containing the AV content identifier and the start request position information that is the information indicating the determined start request position, a reception step of receiving the AV contents in response to transmission of the reproduction start request, and a reproduction step of reproducing the received AV content.

Also, the software for implementing the AV server in this embodiment is the following program. Namely, this program enables a computer to perform a step of receiving a reproduction start request containing the AV contents identifier and the start request position information, a step of determining, as the transmission start position, the top of reproduction block near the start request position indicated by the start request position information, and a step of transmitting the AV content identified by the AV content identifier contained in the received reproduction start request from the transmission start position.

That is, the program of the invention is the program for enabling the computer to perform the functions of all or part of the means in the AV server of the invention as described above, and operated in cooperation with the computer.

Also, a recording medium of the invention records the program for enabling the computer to perform the functions of all or part of the means in the AV server of the invention as described above, and is readable by the computer, whereby the read program performs the functions in cooperation with the computer.

In this invention, “part of means” means one or more means among a plurality of means.

Also, in this invention, “functions of means” means the functions of all or part of the means.

In one use form of the program of this invention, the program may be recorded in the recording medium such as ROM readable by the computer, and operated in cooperation with the computer.

Also, in another use form of the program of this invention, the program may be transmitted across the network such as the Internet, or through the transmission media such as light, electric wave or sound wave, read by the computer and operated in cooperation with the computer.

A data structure of this invention may involve the database, data format, data table, data list or the kind of data.

Also, the computer of this invention is not limited to the pure hardware such as CPU, but may comprise a firmware, OS, or peripheral devices.

As described above, the configuration of the invention may be implemented by software or hardware.

As will be apparent from the foregoing description, with the AV server, the AV contents reproducing apparatus, the AV contents transmitting method, the program and the recording medium according to the present invention, when reproducing the AV content recorded in the AV server via the network, it is possible to reproduce the AV contents from the top of reproduction block, even if the AV contents reproducing apparatus does not have the accurate information regarding the reproduction blocks composing the AV content. Accordingly, the AV contents reproducing apparatus is not required to make an inquiry to the AV server for the information regarding the reproduction blocks of the AV content or to interpret such information, resulting in reduction of the load on the AV contents reproducing apparatus and simplification of the configuration.

What is claimed is:

1. An AV server comprising:
store means of holding one or more AV contents containing video, image and/or audio and composed of a plurality of reproduction blocks;
reproduction request receiving means of receiving an AV content identifier that is the information for identifying the AV content and a reproduction request having the start request position information that is the information indicating the start request position designating from which position to start the reproduction for the AV content identified by said AV content identifier;
transmit data determining means of determining the top of reproduction block as the transmission start position when said start request position indicated by said start request position information is coincident with the top of reproduction block, and determining the top of reproduction block before or after said start request position indicated by said start request position information as the transmission start position when said start request position indicated by said start request position information is not coincident with the top of reproduction block; and
transmitting means of transmitting the AV content identified by said AV content identifier provided in said reproduction request received by said reproduction request receiving means from said transmission start position.

2. The AV server according to claim 1, wherein said transmit data determining means determines the top of reproduction block closest to said start request position indicated by said start request position information as the transmission start position when said start request position indicated by said start request position information is not coincident with the top of reproduction block.

3. The AV server according to claim 1, wherein said transmitting means transmits the transmission start position information that is the information indicating said transmission start position.

4. The AV server according to claim 1, wherein said reproduction request received by said reproduction request receiving means has the end request position information that is the information indicating the end request position designating at which position to end the reproduction for the AV content identified by said AV content identifier,
said transmit data determining means obtains the request size from said start request position indicated by said start request position information and said end request position indicated by said end request position information, and determines the transmission position so that the transmit data amount is less than or equal to said request size, and the end of transmit data is matched with the end of any one of said reproduction blocks, and
said transmitting means transmits said AV content in a range from said transmission start position to said transmission end position.

5. The AV server according to claim 1, wherein said reproduction request received by said reproduction request receiving means further has the request size information that is the information indicating the request size, said transmit data determining means determines the transmission end position so that the transmit data amount is less than or equal to said request size, and the end of transmit data is matched with the end of any one of said reproduction blocks, and said transmitting means transmits said AV content in a range from said transmission start position to said transmission end position.

6. The AV server according to claim 4, wherein said transmitting means further transmits the transmission end position information that is the information indicating said transmission end position.

7. The AV server according to claim 5, wherein said transmitting means further transmits the transmission end position information that is the information indicating said transmission end position.

8. The AV server according to claim 1, wherein said AV contents are an MPEG video, and each of said reproduction blocks is GOP.

9. The AV server according to claim 1, wherein said AV contents are DVD-VR formatted video, and each of said reproduction blocks is VOBU.

10. An AV contents reproducing apparatus comprising:
user input means of accepting the input having an AV content identifier that is the information for identifying the AV content;
received data determining means of determining the start request position designating from which position to start the reproduction for the AV contents identified by said AV content identifier accepted by said user input means;
reproduction request transmitting means of transmitting said AV content identifier and a reproduction start request containing the start request position information that is the information indicating said start request position;
receiving means of receiving the AV content as a response to said reproduction start request; and
reproducing means of reproducing the AV content received by said receiving means;
wherein said receiving means receives said AV content and the transmission end position information that is the information indicating the transmission end position designating to which position to contain data in said AV content; and
wherein said received data determining means determines the start request position designating from which position to start the reproduction in said AV content identified by the AV content identifier accepted by said user input means, based on said received transmission end position information.

11. An AV transmitting method comprising:
a store step of holding one or more AV content containing video, image and/or audio and composed of a plurality of reproduction blocks;
a reproduction request receiving step of receiving an AV content identifier that is the information for identifying the AV content and a reproduction request having the start request position information that is the information indicating the start request position designating from which position to start the reproduction for the AV content identified by said AV content identifier;
a transmit data determining step of determining the top of reproduction block as the transmission start position when said start request position information is coincident with the top of reproduction block, or determining the top of reproduction block before or after said start request position indicated by said start request position information as the transmission start position when said start request position information is not coincident with the top of reproduction block; and
a transmission step of transmitting the AV content identified by said AV content identifier provided in said reproduction request received by said reproduction request receiving means from said transmission start position.

12. A program for enabling a computer to function as the AV server according to claim 1, said AV server comprising:
store means of holding one or more AV contents containing video, image and/or audio and composed of a plurality of reproduction blocks;
reproduction request receiving means of receiving an AV content identifier that is the information for identifying the AV content and a reproduction request having the start request position information that is the information indicating the start request position designating from which position to start the reproduction for the AV content identified by said AV content identifier;
transmit data determining means of determining the top of reproduction block as the transmission start position when said start request position information is coincident with the top of reproduction block, or determining the top of reproduction block before or after said start request position indicated by said start request position information as the transmission start position when said start request position information is not coincident with the top of reproduction block; and
transmitting means of transmitting the AV content identified by said AV content identifier provided in said reproduction request received by said reproduction request receiving means from said transmission start position.

13. A computer readable recording medium recording the program according to claim 12.

14. An AV server comprising:
store means of holding one or more AV contents containing video, image and/or audio and composed of a plurality of reproduction blocks;
reproduction request receiving means of receiving an AV content identifier that is the information for identifying the AV content and a reproduction request having the start request position information that is the information indicating the start request position designating from which position to start the reproduction for the AV content identified by said AV content identifier;
transmit data determining means of determining the top of reproduction block before said start request position indicated by said start request position information as the transmission start position; and
transmitting means of transmitting the AV content identified by said AV content identifier provided in said reproduction request received by said reproduction request receiving means from said transmission start position.

15. An AV server comprising:
store means of holding one or more AV contents containing video, image and/or audio and composed of a plurality of reproduction blocks;
reproduction request receiving means of receiving an AV content identifier that is the information for identifying the AV content and a reproduction request having the start request position information that is the information indicating the start request position designating from which position to start the reproduction for the AV content identified by said AV content identifier;
transmit data determining means of determining the top of reproduction block after said start request position indicated by said start request position information as the transmission start position; and
transmitting means of transmitting the AV content identified by said AV content identifier provided in said reproduction request received by said reproduction request receiving means from said transmission start position.

16. An AV server comprising:
store means of holding one or more AV contents containing video, image and/or audio and composed of a plurality of reproduction blocks;
reproduction request receiving means of receiving an AV content identifier that is the information for identifying the AV content and a reproduction request having the end request position information that is the information indicating the end request position designating at which position to end the reproduction for the AV content identified by said AV content identifier;
transmit data determining means of determining the end of reproduction block after said end request position indicated by said end request position information as the transmission end position; and
transmitting means of transmitting the AV content identified by said AV content identifier provided in said reproduction request received by said reproduction request receiving means up to said transmission end position.

17. An AV server comprising:
store means of holding one or more AV contents containing video, image and/or audio and composed of a plurality of reproduction blocks;
reproduction request receiving means of receiving an AV content identifier that is the information for identifying the AV content and a reproduction request having the end request position information that is the information indicating the end request position designating at which position to end the reproduction for the AV content identified by said AV content identifier;
transmit data determining means of determining the end of reproduction block before said end request position indicated by said end request position information as the transmission end position; and
transmitting means of transmitting the AV content identified by said AV content identifier provided in said reproduction request received by said reproduction request receiving means up to said transmission end position.

18. An AV server comprising:
store means of holding one or more AV contents containing video, image and/or audio and composed of a plurality of reproduction blocks;
reproduction request receiving means of receiving an AV content identifier that is the information for identifying the AV content and a reproduction request having the start request position information that is the information indicating the start request position designating from which position to start the reproduction for the AV content identified by said AV content identifier;
transmit data determining means of determining the top of reproduction block as the transmission start position when said start request position indicated by said start request position information is coincident with the top of reproduction block, or determining the top of reproduction block before said start request position indicated by said start request position information as the transmission start position when said start request position indicated by said start request position information is not coincident with the top of reproduction block; and
transmitting means of transmitting the AV content identified by said AV content identifier provided in said reproduction request received by said reproduction request receiving means from said transmission start position.

19. An AV server comprising:
store means of holding one or more AV contents containing video, image and/or audio and composed of a plurality of reproduction blocks;
reproduction request receiving means of receiving an AV content identifier that is the information for identifying the AV-content and a reproduction request having the start request position information that is the information indicating the start request position designating from which position to start the reproduction for the AV content identified by said AV content identifier;
transmit data determining means of determining the top of reproduction block as the transmission start position when said start request position indicated by said start request position information is coincident with the top of reproduction block, or determining the top of reproduction block after said start request position indicated by said start request position information as the transmission start position when said start request position indicated by said start request position information is not coincident with the top of reproduction block; and
transmitting means of transmitting the AV content identified by said AV content identifier provided in said reproduction request received by said reproduction request receiving means from said transmission start position.

20. An AV server comprising:
store means of holding one or more AV contents containing an image and/or a voice and composed of a plurality of reproduction blocks;
reproduction request receiving means of receiving an AV contents identifier that is the information for identifying the AV contents and a reproduction request having the end request position information that is the information indicating the end request position designating at which position to end the reproduction for the AV contents identified by said AV contents identifier;
transmit data determining means of determining the end of reproduction block as the transmission end position when said end request position indicated by said end request position information is coincident with the end of reproduction block, or determining the end of reproduction block after said end request position indicated by said end request position information as the transmission end position when said end request position indicated by said end request position information is not coincident with the end of reproduction block; and
transmitting means of transmitting the AV content identified by said AV content identifier provided in said reproduction request received by said reproduction request receiving means up to said transmission end position.

21. An AV server comprising:
store means of holding one or more AV contents containing video image and/or audio and composed of a plurality of reproduction blocks;
reproduction request receiving means of receiving an AV content identifier that is the information for identifying the AV content and a reproduction request having the end request position information that is the information indicating the end request position designating at which position to end the reproduction for the AV content identified by said AV content identifier;
transmit data determining means of determining the end of reproduction block as the transmission end position when said end request position indicated by said end request position information is coincident with the end of reproduction block, or determining the end of reproduction block before said end request position indicated by said end request position information as the transmission end position when said end request position indicated by said end request position information is not coincident with the end of reproduction block; and
transmitting means of transmitting the AV content identified by said AV content identifier provided in said reproduction request received by said reproduction request receiving means up to said transmission end position.
